(19) United States
(12) Patent Application Publication
(10) Pub. No.: US 2005/0117799 A1
(43) Pub. Date: Jun. 2, 2005

(54) METHOD AND APPARATUS FOR TRANSFORMING A HIGH DYNAMIC RANGE IMAGE INTO A LOW DYNAMIC RANGE IMAGE

(76) Inventors: Chiou-Shann Fuh, Taipei Hsien (TW); Chik-Yau Foo, Taipei Hsien (TW); Chao-Yang Kao, Taipei Hsien (TW)

Correspondence Address: NORTH AMERICA INTERNATIONAL PATENT OFFICE (NAIPC), P.O. BOX 506, MERRIFIELD, VA, 22116, US

(21) Appl. No.: 10/707,255

(22) Filed: Dec. 1, 2003

(51) Int. Cl. G06K 9/00

(52) U.S. Cl. 382/169

(57) ABSTRACT

A method and an apparatus for transforming a high dynamic range image into a low dynamic range image. The method includes converting first luminance values associated with pixels into a plurality of second luminance values, and utilizing a film transfer function for mapping the second luminance values associated with the pixels into a plurality of third luminance values to generate the low dynamic range image. A second luminance range of the second luminance values is smaller than a first luminance range of the first luminance values, and the film transfer function adds no visual artifact to the low dynamic range image.

### BACKGROUND OF INVENTION

1. Field of the Invention

The present invention relates to an image processing method. In particular, the present invention discloses a method and an apparatus for transforming a high dynamic range image into a low dynamic range image.

2. Description of the Prior Art

The dynamic range of a scene is defined to be a ratio of the highest scene luminance to the lowest scene luminance. Generally speaking, a standard display device such as a CRT monitor or an LCD monitor has a dynamic range of about 250:1, and covers about half of the visible color gamut. However, the human vision system (HVS) has a dynamic range greater than 10,000:1, and is capable of distinguishing about 10,000 colors at a given brightness. In addition, a computer-generated image (CGI) commonly has a factor of 3000 between the highest and lowest intensity values.

Typically, the image displayed on the standard display device corresponds to intensities spanning 256 gray levels. That is, each color channel (R, G, B) is determined by 8 bits. Therefore, the minimum gray level is equal to 0, and the maximum gray level is equal to 255. From the above description, it is obvious that the dynamic range in real-world environment far exceeds the representable dynamic range shown on the standard display device.

An image having a great dynamic range is commonly called a high dynamic range (HDR) image. Currently, there is no simple and direct method to capture and render the high dynamic range images. One technique of capturing HDR images involves the use of multiple exposures for the same scene. Therefore, a plurality of images corresponding to the same scene are obtained, but the images are captured at different exposures. That is, the differently exposed images provide different luminance data. Then, the images are combined together via a prior art algorithm to determine the real radiance levels of the scene, and the HDR image corresponds to the wanted scene is obtained.

Having successfully recorded the HDR images, the next step is to store the images. Existing digital image formats are mostly adopted for conventional display devices. As mentioned above, images commonly use 8 bits to store each color channel for driving standard display devices successfully. It is obvious that the corresponding dynamic range of the prior art format is insufficient for the HDR image data. Then, several file formats have been developed to solve this problem. The simplest way to increase the dynamic range available to digital images is to increase the number of bits per channel. One example is the logLuv encoding scheme that uses 4 bytes per pixel. It is well-known that 2 bytes are used for encoding the logarithm of the luminance Y, and the other two bytes are used for encoding the u channel and v channel of the Luv color space.

After the HDR image is successfully generated, a tone mapping procedure is used for reproducing the captured scene on a standard display device with the help of the rendered HDR image. In other words, the tone mapping process converts the luminance values recorded by the HDR image into luminance values suitable for driving the standard display device with a low dynamic range. Therefore, the main objective of the tone mapping procedure is to compress the wide dynamic range to fit the dynamic range of the standard display device. It is well-known that a tone reproduction curve (TRC) or a tone reproduction operator (TRO) is applied to the image data associated with the HDR image. For the tone reproduction curve, each pixel is transformed from its current luminance value to a new display intensity within the dynamic range of the standard display device. The tone reproduction curve corresponds to a transformation function that is independent of spatial distribution, and every pixels of the HDR image are processed by the same transformation function. Regarding the tone reproduction operator, spatial context is used for adjusting luminance of each pixels. That is, two pixels of the same luminance value may be mapped to different display intensities with the dynamic range of the standard display device, or two different luminance values may be mapped to the same display intensity within the dynamic range of the standard display device.

Tone mapping techniques can also be used to tune the display quality of the captured HDR images. For example, the prior art tone mapping process will simulate the response of the human eye. Please note that the HDR image is formed by combining many images captured at different exposures. That is, the rendered HDR image originally has no visual artifact. However, the human vision is full of visual artifacts such as glares at higher luminance and blurs at lower luminance. Therefore, the prior art tone mapping process will introduce the visual artifacts inherent in human vision into the LDR image rendered from the HDR image. Though the final LDR image shown on the standard display device corresponds to what an observer sees the captured scene, the image quality is degraded owing to the introduced visual artifacts. In addition, it requires complicated real-time calculation to add the wanted visual artifacts into the LDR image, and the time-consuming computation certainly leads to poor image processing efficiency.

### SUMMARY OF INVENTION

It is therefore a primary objective of this invention to provide a method and an apparatus for transforming a high dynamic range image into a corresponding low dynamic range image.

Briefly summarized, the preferred embodiment of the present invention discloses a method for converting a high dynamic range image into a low dynamic range image. The high dynamic range image has a plurality of pixels, and the pixels respectively correspond to a plurality of first luminance values. The method includes following steps: (a)converting the first luminance values associated with the pixels into a plurality of second luminance values, a second luminance range of the second luminance values being smaller than a first luminance range of the first luminance values, and(b)utilizing a film transfer function for mapping the second luminance values associated with the pixels into a plurality of third luminance values to generate the low dynamic range image, wherein the film transfer function adds no visual artifact to the low dynamic range image.

The preferred embodiment of the present invention also discloses an image processing system. The image processing system comprises an image generator for generating a high dynamic range image, wherein the high dynamic range image has a plurality of pixels, and the pixels respectively corresponding to a plurality of first luminance values, and an image processing logic for converting the first luminance values associated with the pixels into a plurality of second luminance values and utilizing a film transfer function for mapping the second luminance values associated with the pixels into a plurality of third luminance values without adding visual artifacts to generate a low dynamic range image. In addition, a second luminance range of the second luminance values is smaller than a first luminance range of the first luminance values.

It is an advantage of the present invention that a film transfer S-curve is utilized. The resulting LDR image is a realistic-looking photograph without the visual artifacts, and the final LDR image shown on the standard display device is clear. With the help of the film transfer S-curve, contrast for pixels originally with luminance value in the middle luminance range is improved, and corresponding details are clearly shown. In addition, the film transfer S-curve is pre-defined, and is not calculated during the tone mapping process. Therefore, it is easier to implement the claimed method, and the image processing performance is better than before.

These and other objectives of the present invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a flow chart of a tone mapping process according to the present invention.

FIG. 2 is a schematic diagram illustrating a global gradient compression according to the present invention.

FIG. 3 is a schematic diagram of a film transfer S-curve according to the present invention.

FIG. 4 is a block diagram of an image processing system according to the present invention.

### DETAILED DESCRIPTION

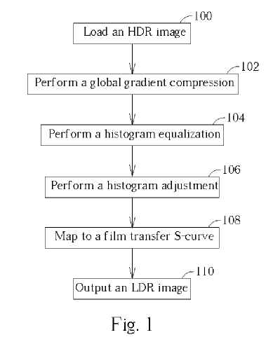

Please refer to FIG. 1, which is a flow chart of the tone mapping process according to the present invention. The tone mapping process according to the present invention is described as follows. First, an HDR image is loaded (step 100). The HDR image, as mentioned above, is generated from a plurality of images captured at different exposures, and the HDR image corresponds to a wide dynamic range greater than that of a standard display device. Therefore, the original dynamic range of the inputted HDR image needs to be compressed into a new low dynamic range available to the standard display device. In addition, the human visual system is not very sensitive to absolute luminance, but rather responds to local luminance changes and reduces the effect of large global illumination differences. Therefore, a global gradient compression is performed to compress the original dynamic range and reduce the global illumination differences. In order to simplify computation complexity and implementation, a spatially invariant operator is given by:

$${L}_{d} ( x , y ) = \frac{{L}_{w} ( x , y )}{1 + {L}_{w} ( x , y )} \qquad Equation ( 1 )$$

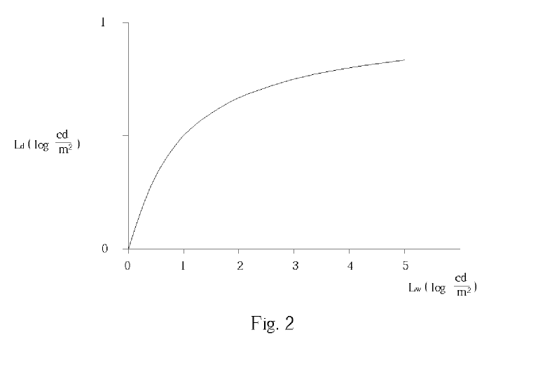

The L_{W} (x,y) represents a “world” or “raw” luminance for the pixel (x,y) on the HDR image, and the L_{d} (x,y) represents a scaled luminance corresponding to the pixel (x,y). Please refer to FIG. 2, which is a schematic diagram illustrating the global gradient compression according to the present invention. As shown in FIG. 2, the L_{d} (x,y) corresponds to a normalized gray level for the standard display device, that is, the L_{d} (x,y) lies in the interval [0,1]. It is obvious that L_{W} (x,y) corresponding to a high luminance value is approximately scaled by L_{W} (x,y) itself, and the L_{W} (x,y) corresponding to a low luminance value is approximately scaled by 1. The denominator causes a graceful blend between these two scalings, and the equation (1) is guaranteed to bring all world luminance values into an available dynamic range. For example, the original high luminance values are greatly compressed to be available display luminance values for a specific display device.

Then, a histogram equalization is performed to improve contrast of the adjusted image associated with the scaled luminance values (step 104). The histogram equalization transforms the histogram of the adjusted image into an approximately uniform histogram. Suppose that a cumulative frequency distribution P(b) is needed to equalize a histogram, and the cumulative frequency distribution P(b) is defined as:

$$P ( b ) = \frac{{\sum }_{{b}_{1} < b} f ( {b}_{i} )}{T} \qquad Equation ( 2 )$$

The symbol T stands for the total number of histogram entries. Therefore, P(bᵢ) is the frequency distribution for the histogram bin at bᵢ, and f(bᵢ) is the frequency count for the histogram bin at bᵢ. The histogram equalization applied to an inputted image would produce an outputted image whose brightness values have equal probability. The equalization formula can be written as: B_{d}=log(L_{dmin})+[log(L_{dmax})−log(L_{dmin})]*P(B) Equation (3)

The symbol B_{d} represents the adjusted display brightness, and the symbol B stands for the raw image brightness. The log(L_{dmin}) is the minimum brightness shown on the standard display device, and the log(L_{dmax}) is the maximum brightness shown on the standard display device. After re-distributing luminance values of the pixels in the inputted image, the outputted image then has better contrast to display more details.

However, if half the pixels have luminance values lower than 0.2*L_{dmax}, that is, a small luminance range [0,0.2*L_{dmax}] will use half of the available display luminance values shown on the standard display device. Therefore, the contrast of the adjust image may be overemphasized. For instance, suppose that two adjacent pixels of the raw image originally have a small luminance difference. After the above histogram equalization is performed, the luminance difference is enlarged. This results in an unnatural appearance of the image, and the display quality is also degraded. Therefore, a histogram adjustment is executed to prevent the contrast of the final image from being amplified exaggeratedly (step 106). The histogram adjustment limits the contrast by implementing a ceiling condition. In the preferred embodiment, the ceiling condition is implemented as follows:

$$\frac{ⅆ {L}_{d}}{ⅆ L} \leq \frac{{L}_{d}}{L} \qquad Equation ( 4 )$$

The equation (4) implies that the contrast cannot exceed the contrast obtained by using a well-known linear scaling operation whose slope is equal to L_{d}/L. From the equation (2) mentioned above, it is well-known that following inequality is derived:

$$f ( b ) \leq \frac{T * Δ b}{log ( {L}_{d max} ) - log ( {L}_{d min} )} \qquad Equation ( 5 )$$

The symbol Δb stands for [log(Lₘₐₓ)−log(Lₘᵢₙ)]/N, wherein N is the number of histogram bins, log(Lₘₐₓ) is the maximum brightness for the raw image, and log(Lₘᵢₙ) is the minimum brightness for the raw image. Therefore, the symbol Δb corresponds to the size of each bin. As hinted by the equation (5), it is sure that the resulting histogram of the adjust image will not exaggerate contrast as long as no frequency count of the histogram bin exceeds the upper bound, that is, L_{d}/L. In the end, the outputted image has no overpopulated histogram bin.

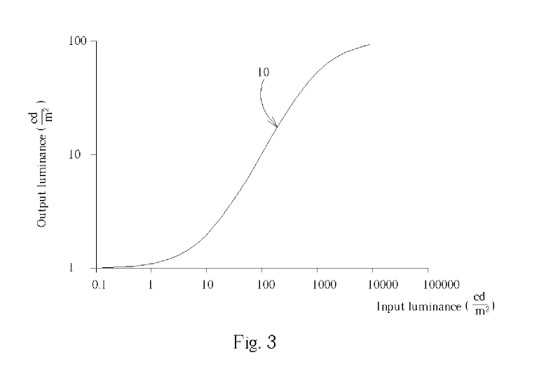

After the step 106 is done, the preferred embodiment activates a mapping operation through utilizing a film transfer S-curve (step 108), and the final LDR image is then successfully generated (step 110). Please refer to FIG. 3, which is a schematic diagram of a film transfer S-curve 10 according to the present invention. The horizontal axis stands for the input luminance, and the vertical axis stands for the output luminance. The film transfer S-curve 10 corresponds to a sensitization response of a photographic film. As shown in FIG. 3, the input luminance values located within the middle range (10˜1000) approximately occupy a full range of the output luminance values. In other words, the film transfer S-curve 10 increases the contrast of the middle luminance regions in the image. Therefore, the contrast corresponding to the high luminance regions and the low luminance regions is greatly depressed. That is, the perceived quality of the final LDR image is greatly improved.

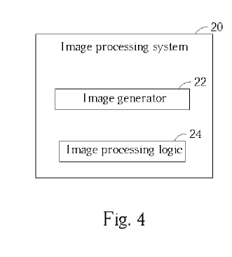

The tone mapping process according the present invention is capable of being run on an image processing system for transforming an HDR image to an LDR image. Please refer to FIG. 4, which is a block diagram of an image processing system 20 according to the present invention. The image processing system 20 comprises an image generator 22 and an image processing logic 24. The image generator 22 is capable of generating a high dynamic range image, and the image processing logic 24 is capable of performing a tone mapping process to transform the HDR image into a corresponding LDR image. For instance, the image processing system 20 is a digital camera. The image generator 22 within the digital camera includes a CCD module for capturing incident light to generate a corresponding image and a camera shutter for controlling the exposures of the CCD module. Therefore, the image generator 22 can capture a scene via the CCD module, and is capable of generating a plurality of images captured at different exposures through appropriately controlling the camera shutter. Then, the image generator 22 generates an HDR image corresponding to the captured scene by combining these images together according to the prior art algorithm.

The image processing logic 24 then is activated to process the HDR image. Therefore, the image processing logic 24 runs the steps 102, 104, 106, 108 to render the desired LDR image. Because the image processing logic 24 such as a digital signal processor (DSP) utilizes a simple film transfer function, the related computation is simple. Generally speaking, the digital camera has a small LCD screen for previewing the captured scene. Because the image processing logic 24 has better image processing efficiency by using the simple film transfer function, a user can quickly preview the LDR image on the LCD screen. In addition, the rendered LDR image has better picture quality because no visual artifact is added to the LDR image.

Another embodiment is that the image generator 22 can capture a scene to generate a plurality of images captured at different exposures only. Then, the required HDR image is further rendered by the image processing logic 24. Similarly, the image processing logic 24 also is capable of running the steps 102, 104, 106, 108 to render the final LDR image.

As mentioned above, the image processing system 20 is a digital camera so that the image generator 22 and the image processing logic 24 are positioned in the same housing. However, the image processing system 20 can be built by individual apparatuses. For example, the image generator 22 is a digital camera, and the image processing logic 24 corresponds to a computer host. Therefore, the image data outputted from the image generator 22 are delivered to the external image processing logic 24 for following advanced image processing.

As mentioned above, the prior art adds visual artifacts to the final LDR image so as to stress the visual accuracy. However, the display quality of the LDR image is worsened owing to the introduced visual artifacts. In addition, the time-consuming reproductions of human visual artifacts, such as glares at higher luminance and blurs at lower luminance, deteriorates the image processing performance. In contrast to the prior art, the present invention adopts a film transfer S-curve instead. The resulting LDR image is a realistic-looking photograph without the visual artifacts, and the final LDR image shown on the standard display device is clear. With the help of the film transfer S-curve, contrast for pixels originally with luminance value in the middle luminance range is improved, and corresponding details are clearly shown. In addition, the film transfer S-curve is pre-defined without being dynamically calculated during the tone mapping process. Therefore, the implementation of the claimed tone mapping process is easy, and the image processing performance is better.

1. A method for converting a high dynamic range image into a low dynamic range image, the high dynamic range image having a plurality of pixels, the pixels respectively corresponding to a plurality of first luminance values, the method comprising following steps:
(a) converting the first luminance values associated with the pixels into a plurality of second luminance values, a second luminance range of the second luminance values being smaller than a first luminance range of the first luminance values; and
(b) utilizing a film transfer function for mapping the second luminance values associated with the pixels into a plurality of third luminance values to generate the low dynamic range image, wherein the film transfer function adds no visual artifact to the low dynamic range image.

2. The method of claim 1 further comprising:
(c) performing a histogram equalization to adjust the second luminance values distributed among the pixels.

3. The method of claim 2 wherein step (c) further comprises:
preventing a total number of predetermined pixels corresponding to a second luminance value from being greater than a predetermined limit.

4. The method of claim 1 wherein step (a) is performed by a global gradient compression.

5. An image processing system comprising:
an image generator for generating a high dynamic range image, the high dynamic range image having a plurality of pixels, the pixels respectively corresponding to a plurality of first luminance values; and
an image processing logic for converting the first luminance values associated with the pixels into a plurality of second luminance values and utilizing a film transfer function for mapping the second luminance values associated with the pixels into a plurality of third luminance values without adding visual artifacts to generate a low dynamic range image;
wherein a second luminance range of the second luminance values is smaller than a first luminance range of the first luminance values.

6. The image processing system of claim 5 being a digital camera.

7. The image processing system of claim 5 wherein the image generator is capable of capturing a plurality of images with different exposures for generating the high dynamic range image.

8. The image processing system of claim 5 wherein the image processing logic is capable of performing a histogram equalization to adjust the second luminance values distributed among the pixels.

9. The image processing system of claim 8 wherein the image processing logic is capable of preventing a total number of predetermined pixels corresponding to a second luminance value from being greater than a predetermined limit.

10. The image processing system of claim 5 wherein the image processing logic is capable of performing a global gradient compression to convert the first luminance values into the second luminance values.
